(19) United States
(12) Patent Application Publication
(10) Pub. No.: US 2010/0228365 A1
(43) Pub. Date: Sep. 9, 2010

(54) METHOD FOR CREATING REQUIREMENTS SPECIFICATIONS FOR PROCESS CONTROL SYSTEMS FOR POWER PLANT INSTRUMENTATION AND CONTROL TECHNOLOGY

(76) Inventors: Gunther Chrobok-Diening, Gilching (DE); Dieter Kleyer, Herzogenaurach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/717,333

(22) Filed: Mar. 4, 2010

(30) Foreign Application Priority Data
Mar. 4, 2009 (DE) 10 2009 011 724.5

(51) Int. Cl. G05B 19/42; G06F 1/26; G06F 9/44

(52) U.S. Cl. 700/86; 700/286; 717/121

(57) ABSTRACT

A method for supporting the creation of a requirements description for a process control system for power plant instrumentation and control technology is provided. To create a technically clear requirements description for a process control system for power plant technology, a textually formulated requirements description is checked for the observance of previously specified formulation rules directed at the design of the process control and, technically ambiguous passages of text according to the formulation rules are output for revision.

### CROSS REFERENCE TO RELATED APPLICATIONS

This application claims priority of German application No. 10 2009 011 724.5 DE filed Mar. 4, 2009, which is incorporated by reference herein in its entirety.

### FIELD OF INVENTION

The invention relates to a method for supporting the creation of a requirements description for a process control system for power plant instrumentation and control technology.

### BACKGROUND OF INVENTION

The functional scope of process control systems in power plant instrumentation and control technology is steadily increasing and is nowadays many times that of older systems. The functional scope of process control systems in power plant instrumentation and control technology includes so-called non-functional features such as reaction time, maintainability or fault tolerance. The number of these non-functional features is increasing to the same degree as the functional scope. As a consequence, there has been a significant increase in the complexity of the systems which have been technically implemented to date. It is to be expected that this rate of development will persist in future and may even increase.

At the start of the development of a process control system in power plant instrumentation and control technology, that is a software- and hardware-based control system for controlling a power plant, a so-called requirements description is created. This is intended to define the requirements of the customer or the market regarding the functional scope and the non-functional features of the power plant process control system to be developed. The requirements description specifies what the process control system it is supposed to accomplish in the power plant technology and the way in which is supposed to achieve this for the user.

In the further course of the development of a process control system for a power plant, so-called functional specifications will then be developed on the basis of the requirements descriptions. In addition to the functional features, these can also specify non-functional features. They take into account the customer and market requirements and specify and itemize these in contrast to the requirements description from a technical viewpoint and take into account existing attendant technical conditions. A functional specification lays down how, and in what manner, the process control system of the power plant is supposed to function.

The requirements description and the technically more precise functional specification for a process control system are set down in a human language and in text form. Engineers and computer scientists have also developed formal and semi-formal modeling languages for the precise specification of functions and behavior. Modeling languages of this kind enable special aspects to be expressed more precisely than in a normal text description. They are a further description tool, although they do not render textually formulated requirements superfluous.

### SUMMARY OF INVENTION

It is an object of the present invention to disclose a method to support the creation of a technically clear requirements description for a process control system for power plant technology.

The object is achieved by a method of the type named in the introduction in which a textually formulated requirements description according to the invention is checked to ensure observance of previously specified formulation rules directed at the design of the process control system and technically ambiguous text passages according to the formulation rules are output for revision. This enables the number of residual errors in the power plant technology process control system to be reduced and misunderstandings and misinterpretations to be avoided during the development of the process control system.

The invention is hereby based on the consideration that, to date, requirements descriptions for process control systems for power plant instrumentation and control technology are as a rule all formulated linguistically in text form. Here, both individual sentences and whole paragraphs of different lengths are used to describe different requirements. A textually formulated early version of a requirements description of this kind can be described as a free text requirement. It is to be expected that, even in future, requirements descriptions for even more complex process control systems will be written as free text requirements, since it cannot be assumed that all participating groups of people are sufficiently competent in modeling languages and there are still problems with the acceptance of formal and semi-formal modeling languages. In addition, the flexibility of language as the first universal means of expression for humans is desirable and has advantages.

In the development process for a power plant process control system, a requirements description for the process control system is extremely important since this forms the basis and the starting point for the correct creation of the, sometimes extremely complex, process control system. It forms the basis for a functional specification, then for the draft process control system, then for its implementation and finally for the tests accompanying the development and integration. In addition, the requirements description represents the basis of the tests to be performed before market introduction

These tests are used to check whether the process control system in its final form actually satisfies all the requirements required in the requirements description. For example, a check is performed to see whether the already polished functional specification of the process control system takes account of the functional scope required in the requirements description including the non-functional features. Hereby, development engineers verify the functional specification of the process control system with reference to the requirements description. In a market introduction test, a further test is performed to see whether the final process control system satisfies the functional specification. To this end, test engineers verify the process control system with reference to the functional specification. A check is also performed to see whether the process control system also satisfies the original requirements description. If the requirements description is unclear, errors may remain in the process control system without this being detected in the tests.

During the course of a product development process for a process control system for power plant instrumentation and control technology, several groups of people come into contact with the requirements description as authors and readers, for example, members of the sales staff, external partners, planning engineers, product managers, project managers, development managers, development engineers, test engineers and maintenance engineers. It is not to be expected that all these groups of people will interpret a free text requirement in exactly the same way with respect to the technical features. However, this is necessary for the development of a reliable process control system satisfying all the customer's requirements.

The development process for the implementation of a process control system for power plant instrumentation and control technology is, in principle, divided into three phases. Firstly, a product manager, for example, uses his understanding of process control systems in power plant technology to introduce the general requirements and special requirements of the customers and of the market into the requirements description. Following, a free text requirement of this kind, the product development process generally provides for a revision in the form of a review and provides an already somewhat more precise requirements specification with free text requirements.

In the second development phase, a development manager, for example, analyses the free text requirements with the aim, depending upon the complexity of the process control system, of creating one or more functional specifications. Frequently, in addition to these functional specifications, so-called function lists are created, which use tables and key words to establish a link between the requirements in the requirements description and development-related specifications. The aim of this is to establish traceability, that is the possibility of using tests to check precisely whether all the requirements in the requirements description are also really satisfied.

In addition, to the free text requirement, in the following, a requirements specification, a functional specification or a textual specification in another stage of the development of the process control system will also be referred to as a textually formulated requirements description.

In a third phase, the process control system is implemented and tested. To this end, development engineers, for example, implement the process control system on the basis of the functional specification and the function lists and test engineers test the process control system before delivery to the customers.

Since a free text requirement has too many possibilities for unclear formulations, but, due to insufficient acceptance and competence, it is not possible to resort to modeling languages, it is advantageous to formalize the language of a textually formulated requirements description. Technically ambiguous text passages can be identified by referring to the formalization rules and output for revision.

Hereby, the output can be sent to an automatic correction editor or to a human formulator so that both automatic and human correction is feasible. By means of formulation rules directed at the design of the process control system, the free text can be formulated according to the formulation rules, with advantageously all formalized text passages being defined with respect to their whole meaning or in the meaning of individual words, for example with reference to a list of definitions or a dictionary. The technical orientation of the formulation rules is achieved in that the rules enable the text to be examined with respect to its technical information, for example with respect to non-ambiguity.

The method is advantageously executed by means of a computer in which the formulation rules are stored and which checks the textually formulated requirements description, in particular autonomously, e.g. passage for passage. The processing of the textually formulated requirements description to be checked is advantageously performed in ASCII format. This enables IT-readability to be guaranteed even if word processing programs have changed in a few years time. This facilitates documentation over a lengthy period.

The checking of the requirements description can even take place while a person is inputting the text of the requirements description. Advantageously, the check is started by an operator's input command, for example, when the operator has formulated a passage of the requirements description.

The computer program advantageously provides at least one suggested change for a technically ambiguous text passage which eliminates the ambiguity and contains technically unambiguous wording. Advantageously, an input field is provided for a change to an ambiguous text passage. To ensure that formalization of the text is not enforced and that free text requirements are permitted in individual cases, the computer program has an input command providing the possibility of ignoring a rule infringement and, for example, leaving the text as it is.

Formulation rules can be dictionaries in which terms are defined or those in which synonyms are assigned so that the same term is always used in a requirements description and not synonyms. Formulation rules can be technical descriptions of terms or rules and principles commonly used in Requirements Engineering, that is with respect to requirements for process control systems for power plant instrumentation and control technology.

Advantageous further embodiments of the inventions have features with which at least one of the practical problems described below can be eliminated in the implementation and maintenance of process control systems for power plant instrumentation and control technology.

Binding Force:

Initial free text requirements frequently lack the clear expression of an unambiguous binding force of the requirements. Even in the revised free text requirements, there may be no clear statements regarding the binding force of the requirements. The binding force of requirements will therefore be interpreted in the further course of the development and can deviate from the binding force originally intended or agreed with customers. Advantageously, therefore, the binding force of words associated with a binding force verbs such as “shall”, “should”, “can” can be defined in at least one formulation rule. If undefined expressions are used in a textually formulated requirements description to provide binding force, this can be output as a technically ambiguous text passage with a reference to the fact that it is necessary to establish the binding force, for example whether a requirement absolutely has to be implemented or whether this is left to the discretion of the developer. Advantageously, the textually formulated requirements description is divided into several individual requirements and each of the requirements is then checked to see whether it is provided with a word defining the binding force of the requirement, the definition of which is stored in a formulation rule.

Additional Information:

In addition, the actual requirements, requirements descriptions can also contain additional information, for example hardware conditions or customers' motives for certain requirements. Hereby, additional information does not necessarily have to be classed as requirements and should advantageously be identified as additional information. Advantageously, they will not be checked according to the same formulation rules in the further course of the process and can, for example, be unformalized or only partially formalized. Advantageously, the textually formulated requirements description is divided into requirements which are checked and additional information which is not checked.

Complex Content:

Requirements descriptions frequently express complex content in short words, but in doing so leave wide margins for interpretation in the subsequent development phases. Overall, even at the start of development, there is a risk that communication errors could result in serious and costly development failures. To avoid problems of this kind, unclear text passages according to the formulation rules are advantageously reformulated according to the formulation rules, so that the reformulated text exclusively comprises requirements for the process control system which are unambiguously defined in the formulation rules. A reformulation can be output as a suggested change, which is confirmed by an operator or changed again. The reformulation can also be automated and take place without any intervention on the part of the operator.

Synonyms:

The use of synonymous terms reduces the non-ambiguity of a textually formulated requirements description. To avoid this, the textually formulated requirements description is advantageously examined for synonyms which can be stored, for example in dictionaries or thesauruses. If any synonyms are found, they will be output as unclear passages of text so that it possible to check whether the same term or actually different terms are desired.

Non-Atomic Requirements:

Free text requirements frequently contain several requirements to be understood separately from each other in one paragraph or even in one sentence. This impedes the clear separation of requirements from the very beginning, in particular the traceability of individual requirements right up to requirements in the functional specifications. Several linked requirements in one sentence are, therefore advantageously separated or atomized so that they are also linguistically clearly separated from each other. To this end, it is advantageous for several requirement elements formulated as interconnected or requirements for the process control system in individual requirements in the textually formulated requirements description to be broken up into one sentence each.

Fields of Knowledge and Language Worlds:

Knowledge from numerous fields of knowledge is vital for the creation of a process control system. The groups of people working in the different fields of knowledge frequently work in different language worlds. Extensive experience with process control systems in power plant instrumentation and control technology, on the one hand, and detailed knowledge of IT or technical solutions for the implementation of the requirements, on the other, are inevitably inhomogeneously divided between the participants. To resolve this problem, it is suggested that individual terms in the formulation rules are defined in technically unambiguous manner. In technical descriptions, this can be implemented in terms which are stored with the terms and can be used as an explanation. Different language words are also taken into account in technical synonyms so a process or term expressed in one form in one language world and in another form in another language world is correspondingly taken into account in a thesaurus or dictionary with its terms.

Long-Term Aspects, Knowledge Management and Documentation:

Process control systems for power plant instrumentation and control technology are long-term capital goods. Individual components sometime are to be available for up to twenty years, in the nuclear field for much longer. Therefore, it is frequently necessary to redevelop their functions during the course of a products lifetime, if, for example, hardware is no longer available or individual components are or have been discontinued. In process control systems for power plant instrumentation and control technology, maintenance work and product modifications take place a long time after the requirements specification or requirements description phase. Therefore, it has to be possible to operate knowledge management over periods of many decades. If this fails, a situation will arise in which the system has functions or features the existence of which can no longer be justified. If modifications and expansions of process control systems for power plant instrumentation and control technology are to be performed economically for decades, the data format in which the requirements description is stored has to be IT-readible. The data format is therefore advantageously an ASCII format.

Review Efficiency and Review Effectiveness:

Requirements descriptions for process control systems in power plant instrumentation and control technology are usually distributed to reviewers from the fields of software, marketing, national company, development and implementation before their release. These reviewers are tasked with the provision of corrections to facts and contents, additions or deletions for the requirements description. The accuracy and flawlessness of the technical aspects can only be evaluated and guaranteed on the basis of the specialist and domain knowledge of the reviewer group. Requirements Engineering recognizes numerous basic rules and principles for the formulation of requirements. This can be referred to when checking the textually formulated requirements description. The authors of the textually formulated requirements description often lack the relevant know-how, or fail to apply it due to time pressure. An infringement of a rule by an author, on the one hand, impairs the activity of all reviewers because it has a detrimental effect on features affecting the understandability of text such as the simplicity, structure and conciseness of the requirements text. This affects the efficiency of the review since less understandable text takes longer to read than understandable text. The use of formulation rules and the reformulation of technically ambiguous passages of text of the requirements description can render it easy to read and significantly reduce the reviewer's correction work. This also has a positive effect on the effectiveness, that is the success, of the review, because infringements of rules can mask other defects in the facts or contents in the requirements description so that they remain unidentified. This can reduce reviewing costs and improve effectiveness.

In an exemplary embodiment of the invention, a tool-based semi-automatic post-editing of textually formulated requirements descriptions for process control systems for power plant instrumentation and control technology advantageously processes input in ASCII-Format. This ensures IT-readability. The computer program examines the requirements description with reference to the normal rules and principles relating to requirements for process control systems for power plant instrumentation and control technology.

The invention is also directed at an apparatus to support the creation of a requirements description for a process control system for power plant instrumentation and control technology. According to the invention, the apparatus comprises a data processing means which is programmed to check a textually formulated requirements description to ensure observance of previously specified formulation rules and output technically ambiguous passages of text according to the formulation rules for revision.

The data processing means can be programmed by a suitable computer program to carry out the checking and outputting. This is advantageously performed so that it is able to perform one, several or all of the steps described above.

### DETAILED DESCRIPTION OF INVENTION

The invention will now be explained with reference to several exemplary embodiments.

A textually formulated requirements description is entered by a person via a keyboard into a data processing system with a computer program.

The computer program first differentiates between the actual requirements and the additional information explaining these requirements. This can be performed in that the person inputting the text differentiates between the actual requirements and the additional information and identifies the two groups in a machine-readable way by means of a previously specified flag. In a more advanced variant, the computer program itself examines the text input to see whether a sentence, or a part of a sentence separated by at least one comma, should be interpreted as a requirement or as additional information. This can take place by means of a semantic test, for example a search for the words “should”, “can”, “may” and the like which indicate an actual requirement or by other words which indicate additional information. Advantageously, the text of the requirements description is suitably marked on a screen, for example by color, so that the inputting operator can check the correctness of the analysis of the computer program and, if appropriate, change the status of a requirement or of additional information to the other category.

The checking of the requirements description is then only performed on the basis of the part of the requirements description containing the actual requirements. The checking is performed with reference to a rule catalog. Ambiguous passages of text are output for revision with the operator having the option of revising the relevant text passage or ignoring a revision instruction. The revision can be performed by changing a word or a part of a sentence. It is also possible to redefine a word and add it to a dictionary or a thesaurus. The option of also being able to ignore instructions pays consideration to acceptance by the participants. They are at liberty to disregard instructions and rules of Requirements Engineering. This can improve the quality of a requirements description without enforcing a specific wording. If an entry is made to the effect that an ambiguous text passage or rule linked thereto is to be ignored, the system checks whether it is permissible to ignore this. This is because it is possible to specify that that only certain rules of the rule catalog may be ignored and others may not. An example of a rule which should not be ignored is the binding force. If an operator inputs that a rule of this kind should be ignored, he will be notified that it is not permissible to ignore the rule and the ambiguous text passage remains output for revision.

The list below contains a selection of formulation rules from the Requirements Engineering catalog, which have been specially chosen or put into concrete terms for process control systems in power plant technology and are accessible to tool-based semiautomatic post-editing of textually formulated requirements descriptions.

Binding Force (R1)

Every requirement shall have a defined binding force. The binding force of requirements specifies the agreement made between Product Management, on the one hand, and Product Development and Product Testing, on the other, with respect to the requirements contained in this requirements description. For example, can the binding force can be differentiated by the use of the terms “shall”, “should”, “can”, “may not” and “should not” and be assigned the following meanings:

“shall” signifies an obligation. The product manager issues requirements of this kind unconditionally. Developers absolutely have to satisfy them. No deviations are permitted.

“should” signifies desire. The implementation of requirements of this kind is desired. Developers should implement this requirement.

“can” signifies a possibility suggested by the product manager. Requirements of this type are optional. They can also be possible suggested implementations. Developers decide whether the requirement will be implemented and optionally whether the implementation take place in the suggested way or otherwise.

“may not”. Such requirements prohibit the implementation of a feature or a property or the use of a specific solution. A requirement of this kind could be changed into a “shall” requirement, but the additional possibility of the binding exclusion has been found to be useful if a features or property known from past is to be excluded in a short, concise way.

“should not”: this term in a requirement recommends that a feature be excluded or a property be avoided or a specific solution be avoided. A requirement of this kind could be changed to a “should”, but here, the additional possibility of the exclusion has been found to be useful in porting projects.

If one of these words is found during the checking of the text, the defined meaning of the word will be displayed, e.g. in a screen window or with by highlighted marking in the text and a request made for confirmation that this is the meaning actually desired requested.

In the wording of the following rules, rule (R1) was used.

Atomicity (R2)

Every requirement should consist of one sentence, but not be linked to further requirements by “and”. Several sentences in one paragraph are changed to individual paragraphs each with only one requirement and optionally explanatory additional information, which does not itself represent any requirements. To this end, a sentence or part of a sentence can be examined to see whether it contains several of the words listed under R1. If this is the case, a suspected breach of the rule of atomicity is output and a separation suggested.

Active Voice (R3)

Each requirement should be worded in the active voice. Passive wording will be highlighted and hence indicated.

Reference Points (R4)

A requirement with a comparative or a superlative must have a reference point. If, for example, a system is to be “quicker”, it should also state what it should be quicker than. The relevant sentence will be searched for comparatives. If a comparative is present, a reference point will be sought, e.g. with reference to the word “than” and the reference point will be marked for confirmation or confirmation requested.

Complete Conditions (R5)

If a condition is given under which a system has to have a property, it should also be stated what is to happen if the condition does not apply. Conditions can be found with reference to the word “if” or “condition” or the like.

Dictionary of Nouns (R6)

The meaning (semantics) of nouns in requirements should be defined in a dictionary for the requirements specification. A dictionary of this kind can be domain specific so that technically different domains of a process control system can each be assigned different dictionaries for the requirements description. Generally, it is possible to examine each noun that occurs in the text for the existence of a definition or only words that occur in a special dictionary created for this method, e.g. system, TXP, user, module, archive, faceplate.

Dictionary of Adjectives (R7)

Adjectives in requirements should defined in a dictionary, for example a domain-specific dictionary, for the requirements description. This applies, for example, to the following adjectives: fast, secure, robust, simple, ease of use, low-overhead. Terms such as, for example “ease of use” or “simple” have in the past given rise to completely different expectations. Not every participant is familiar with the definition of simple, namely: with a maximum of four operator control operations. In a requirements description, a requirement can be worded as follows, for example: TXP shall be able to simulate input signals from analog modules simply The word “simply” is highlighted, defined and confirmation or change is requested. In the case of a change, it is specified that the relevant definition should be included in the text of the requirements description.

Dictionary of Verbs (R8)

The meanings or semantic of verbs in requirements should be defined in a domain-specific dictionary for the requirements specification. Examples of verbs defined for specific domains are: confirm, simulate, report, display, print, load. Otherwise, the checking can proceed as described above.

Nominalizations (R9)

Nouns, which describe a procedure or process and describe something non-concrete, that is so-called nominalizations, should be output in requirements as ambiguous passages of text. The procedures or processes described by the nouns should either be described in more detail as further requirements or the nouns should only be used after a definition has been provided in the dictionary of nouns.

Converting Subordinate Clauses (R10)

Subordinate clauses should either become their own requirements sentences or be attached to the requirement as a comment. Corresponding clarification will be requested.

Formulation Templates (R11)

Individual requirements in a requirements description should be formulated with the help of templates. Templates of this kind are stored as formulation rules. A differentiation is made, for example, between three different templates for independent system activities, for user interactions and for system activities in dependence on other systems:

Independent system activity (a): {the system} SHALL|SHOULD|CAN|MAY NOT|SHOULD NOT <verb in the infinitive> <object and details of object>

Independent system activities subject to a condition (b): [when?] [under what conditions?] {the system} SHALL|SHOULD|CAN|MAY NOT|SHOULD NOT <verb in the infinitive> <object and details of object>

User interaction (a): {the system} SHALL|SHOULD|CAN|MAY NOT|SHOULD NOT OFFER THE OPTION <to whom> <verb in the infinitive> <object and details of object>

User interaction subject to a condition (b): [when?] [under what conditions?] {the system} SHALL|SHOULD|CAN|MAY NOT|SHOULD NOT OFFER THE OPTION <to whom> <verb in the infinitive> <object and details of object>

System activities in dependence on other systems (a): {the system} SHALL|SHOULD|CAN|MAY NOT|SHOULD NOT BE ABLE TO <verb in the infinitive> <object and details of object>

System activities in dependence on other systems under a condition (b): [when?] [under what conditions?] {the system} SHALL|SHOULD|CAN|MAY NOT|SHOULD NOT BE ABLE TO <verb in the infinitive> <object and details of object>

With the tool-based, i.e. executed by a computer program, and semi-automatic, i.e. working with operation responses, or automatic post-editing of textually formulated requirements descriptions for process control systems for power plant technology, advantageously not all rules are applied immediately to a section of text. The reason for this that that text which is greatly in need of improvement, which infringes numerous rules, is difficult to improve if the rule breaches are listed indiscriminately in the continuous text. It is, therefore, advantageous to apply the rules sequentially or groups of rules sequentially to the entire textually formulated requirements description or parts thereof, for example, firstly, rule 1 to the entire requirements description, then rule 2, etc or firstly, a first group of rules, e.g. rules 1 and 2, together and, in a further step, a further group of rules and, in a third step, once again further group of rules, wherein in this context, it is possible for one group to encompass one or more rules. Therefore, successive advantageous subsets of rules are applied. The procedure helps, via several, e.g. four, formulation stages of a textually formulated requirements description, to arrive at a structured requirements description, for example, firstly, from an

initial free text requirement to a
free text requirement, from this to a
text requirement and finally to a
structured text requirement.

A staged procedure of this kind can be executed as follows:

Processing the Initial Free Text Requirement

In the first stage, it is ensured that requirements have a defined binding force. Here, no exceptions are permitted. In addition, the computer program refers to composite requirements linked with “and” in the initial free text requirements so that the user can interactively enable separate, individual free text requirements to develop. Hence, the rules used first are: (R1) binding force (R2) atomicity

Processing Free Text Requirements

At the second stage, the user should be encouraged to take into account a further group of elementary rules of Requirements Engineering for the wording of requirements in order to increase testability, but without, at this stage, leading him to choose his words from the terms defined for specific domains. The rules applied to the free text requirements to achieve the text requirements stage are:

(R3) Active voice

(R4) Reference points

(R5) Full conditions (R9) Nominalizations (R10) Conversion of subordinate clauses

Processing Text Requirements

When transferring from the third to the fourth stage, on the one hand, the vocabulary of the text requirements used should be restricted to the vocabulary for specific domains in order to achieve further clarity of expression. Previously, definitions frequently followed the word “local” in the respective requirements descriptions and hence standardized use of the terms was not guaranteed in either the projects or in an entire domain, for example of the process control systems for power plant technology. Other the other hand, it should be possible to differentiate independent system activities, user interactions and system activities explicitly from each other in dependence on other systems in the requirements.

(R6) Dictionary of nouns

(R7) Dictionary of adjectives

(R8) Dictionary of verbs

(R11) Requirements templates

The following will now explain some of the functions of the procedure with reference to a few specific examples.

An initial textual requirements description states in one section:

ID 283: ES 680 shall enable the source from which the time stamp for the fail-safe solutions is adopted, to be plannable.

In the first testing step, this text is output as unclear with respect to atomicity (R2) since two objects are linked to one condition:

ID 283: ES 680 shall enable the source from which the time stamp is adopted to be plannable.

To resolve this task, the text from a member of the sales staff, for example, is reworded as follows

ID 283: The source, from which the time stamp is adopted, shall be plannable.

ID 284: ES 680 shall enable this.

There is no objection to this text in a second testing step, but, in the third testing step, an objection is raised because a dictionary (R6) requires a stated aim for the noun “time stamp”. The member of the sales staff now supplements the text:

ID 283: The source, from which the time stamp for the APT-S7 is adopted shall be plannable.

ID 284: ES 680 shall enable this.

This text is now tested again in the first step (without objection), then in the second step (without objection) and then in the third step, whereby it is identified in the dictionary entry for the APT-S7 control that this is also possible without a time stamp function. Hereupon, a suitable reference text for the marked text is output. The member of the sales staff now supplements the text once more:

ID 283: The source, from which the time stamp for the APT-S7 is adopted, shall be plannable.

ID 284: ES 680 shall enable this.

ID 285: In the case of APT-S7 solutions with SIMATIC S7-400H without time stamping in the S7-400H, the time stamping shall take place in the AS 620B-S7.

Once again, the revised text is checked in three steps, wherein the term “plannable” is output as unclear in the third step. The program now suggests thesaurus entries, e.g. “configurable”. The member of the sales staff can now look up the definitions of these permissible terms in the dictionary and now change the text to:

ID 283: The source, from which the time stamp for the APT-S7 is adopted shall be configurable.

ID 284: ES 680 shall enable this.

ID 285: In the case of APT-S7 solutions with SIMATIC S7-400H without time stamping in the S7-400H, the time stamping shall take place in the AS 620B-S7.

This text passage is clear and free of objections.

In a next example, the initial text requirement is worded:

“The data handling, the data structures and the data storage in the subsystems may be changed with respect to TXP only insofar that this is absolutely necessary due to the SIMATIC S7 hardware.”

During the first test for binding force (R1), the word “may” is found. However, this is not in the context “may not”, but in conjunction with “only insofar that”. This requirement is only clear with a definition of a reference point (R4), since the word “that” requires a reference point. Hence, the binding force is linked to a reference point. A requirement of this kind easily results in unclarities. Therefore, the text needs to be revised.

Regardless of this unclarity or ambiguity, a further passage would be output for revision, namely “is absolutely necessary”. This wording again describes a binding force (R1), and to be precise, due to the word “necessary”. However, this word not permissible since it is not clear. In this case, it would be left up to a software development engineer to decide what is absolutely necessary is or, in the case of the possibility of a large programming effort, what is not mandatorily necessary.

In a further example:

“AS 620B-S7 has to make available the necessary S7-compatible interfaces for the coupling.”

once again, during the checking of the binding force (R1), the term “has” is out output as an impermissible binding force definition and hence as unclear. It can easily be replaced by “shall”.

In a second checking process, the requirement for interfaces is identified as incomplete (R5). This is because the dictionary states that “interfaces” must be specified. For example, details should be given of which interfaces and data formats are meant.

The following is an example of a nouns dictionary for a operator, whereby, obviously, only a small part of the entire dictionary is shown. The dictionary is used to define nouns.

ID 1305: “Bus system” is the generic term for system bus, terminal bus and multimedia bus.

ID 1306: “Look and Feel” is the style and manner of the user interface and the forms of dialog with the user (masks, menus, contents, dialog options, dialog sequence). It is a stylistic property.

ID 1308: “TXP communication mechanisms” is the generic term for “State transmission, operation and event communication”

ID 1309: A “reference project” consists of the reference configuration and the reference project planning.

ID 1310: The starting base for the porting of TXP to TXP S7 is TXP Release 7.7.

ID 1311: A “mixed system” is a TXP system consisting of programmable controllers AS 620B and AS 620B-S7.

ID 1312: In TXP, “project planning” (activity: project planning) means the creation of the functional plans for the plant component control level YFR, equipment layout plans YDM and YDR and the topology plan YDH. The result of the project planning is loadable and executable code and structure and parameter information and the documentation thereof. Equipment layout plans and topology plans describe the configuration.

ID 1313: “Existing functionality” is the functionality supported by TXP system Release 7.7.

ID 1314: “May not change existing functionality” means that the functionality shall remain supported unchanged and the “new functionality” is to be integrated additively.

ID 1315: “In addition to existing functionality, create new functions” does not mean “To change existing functionality”.

ID 1316: With TXP, SIM encompasses the entirety of all ET modules (ET 200U, ET 200B and ET 200M). For more detailed specifications, the diagrams ET 200U, ET 200B and ET 200M are used.

An example of an entry in a dictionary of adjectives can be

ID 1307: “at least” is used with requirements, if a similar or better property is required.

Other dictionaries are used directly by the program and establish links between terms (nouns, verbs, adjectives, etc.) and conditions or requirements so that it is possible to recognize when a condition is not complete.

The described method will support sales engineers or product managers, for example, as authors of textually formulated requirements descriptions when revising their texts before these texts are sent for further processing. Practical problems with requirements descriptions from the field of process control systems for power plant instrumentation and control technology are avoided during the implementation and maintenance of the process control systems.

In addition, the method according to the invention supports reviewers of textually formulated requirements descriptions, for example managers, development engineers (electrical engineering, software), test engineers (electrical engineering, software), maintenance engineers (electrical engineering, software) when reviewing, that is proof-reading, requirements documents.

In addition, the method according to the invention, supports development engineers from the fields of electrical engineering and software as authors of functional requirements specifications in deriving these functional requirements from a textually formulated requirements description so that the functional specification is consistent with the associated textually formulated requirements description.

1.-13. (canceled)

14. A method for supporting the creation of a requirements description for a process control system for power plant instrumentation and control technology, comprising:
checking a textually formulated requirements description to ensure observance of a plurality of previously specified formulation rules directed at a design of the process control system; and
outputting technically ambiguous passages of text according to the plurality of formulation rules for revision.

15. The method as claimed in claim 14, wherein unclear passages of text according to the plurality of formulation rules are reformulated so that the reformulated text exclusively comprises a plurality of requirements for the process control system which are unambiguously defined in the plurality of formulation rules.

16. The method as claimed in claim 14, wherein in the textually formulated requirements description, a plurality of interconnected formulated requirements for the process control system that occur in one sentence are broken down whereby each individual requirement is contained in one sentence.

17. The method as claimed in claim 14,
wherein the textually formulated requirements description is divided into a plurality of individual requirements, and
wherein each of the plurality of individual requirements is checked to see whether the requirement is provided with a word defining a binding force of the requirement, a definition of the word is stored in a formulation rule.

18. The method as claimed in claim 14, wherein the textually formulated requirements description is examined for comparatives for which there is no reference point.

19. The method as claimed in claim 14, wherein the textually formulated requirements description is examined for a requirement linked to a condition for which there is no instruction describing which requirement should apply in an event of a condition not being satisfied.

20. The method as claimed in claim 14, wherein the textually formulated requirements description is examined for a noun that is not defined in a list.

21. The method as claimed in claim 14, wherein the textually formulated requirements description is examined for an adjective that is not defined in the list.

22. The method as claimed in claim 14, wherein the textually formulated requirements description is examined for the plurality of individual requirements in a template-type form.

23. The method as claimed in claim 14, wherein the textually formulated requirements description is divided into requirements which are checked and additional information which is not checked.

24. The method as claimed in claim 14,
wherein the textually formulated requirements description is checked in a plurality of stages,
wherein each stage includes a plurality of subgroups of rules, and
wherein, after checking each stage, unclear passages of text are changed before checking the next stage.

25. The method as claimed in claim 14, wherein a plurality of suggested amendments are output.

26. An apparatus for supporting the creation of a requirements description for a process control system for power plant instrumentation and control technology, comprising:
a data processing means,
wherein the data processing means is programmed to check a textually formulated requirements description for an observance of a plurality of previously specified formulation rules, and
wherein according to the plurality of formulation rules, the data processing means outputs technically ambiguous passages of text for revision.

27. The apparatus as claimed in claim 26, wherein unclear passages of text according to the plurality of formulation rules are reformulated so that the reformulated text exclusively comprises a plurality of requirements for the process control system which are unambiguously defined in the plurality of formulation rules.

28. The apparatus as claimed in claim 26, wherein in the textually formulated requirements description, a plurality of interconnected formulated requirements for the process control system that occur in one sentence are broken down whereby each individual requirement is contained in one sentence.

29. The apparatus as claimed in claim 26,
wherein the textually formulated requirements description is divided into a plurality of individual requirements, and
wherein each of the plurality of individual requirements is checked to see whether the requirement is provided with a word defining a binding force of the requirement, a definition of the word is stored in a formulation rule.

30. The apparatus as claimed in claim 26, wherein the textually formulated requirements description is examined for comparatives for which there is no reference point.

31. The apparatus as claimed in claim 26, wherein the textually formulated requirements description is examined for a requirement linked to a condition for which there is no instruction describing which requirement should apply in an event of a condition not being satisfied.

32. The apparatus as claimed in claim 26, wherein the textually formulated requirements description is examined for a noun that is not defined in a list.

33. The apparatus as claimed in claim 26, wherein the textually formulated requirements description is examined for an adjective that is not defined in the list.
